(19) United States
(12) Patent Application Publication
(10) Pub. No.: US 2006/0265330 A1
(43) Pub. Date: Nov. 23, 2006

(54) DOCUMENT MANAGEMENT APPARATUS, METHOD OF CONTROLLING SAME, COMPUTER PROGRAM AND STORAGE MEDIUM

(75) Inventor: YUSUKE FUKASAWA, Saitama-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/383,566

(22) Filed: May 16, 2006

(30) Foreign Application Priority Data
May 17, 2005 (JP) 2005-144229

(51) Int. Cl. G06Q 99/00

(52) U.S. Cl. 705/51

(57) ABSTRACT

When an encrypted electronic document is stored, input of a first password that is for decrypting the electronic document is allowed and input of time information on which decryption of the electronic document is permitted utilizing the first password is allowed. The first password and the time information that have been input are stored in a storage unit in association with the encrypted electronic document. If it is determined that the date and time stored in the storage unit has passed, the encrypted electronic document that has been stored in the storage unit is decrypted utilizing the first password. The decrypted electronic document is re-encrypted using a second password.

### FIELD OF THE INVENTION

This invention relates to a document management apparatus, a method of controlling this apparatus, a computer program for implementing this control method, and a storage medium for storing the computer program.

### BACKGROUND OF THE INVENTION

With a conventional system (a management system) for managing electronic documents, it has become possible to encrypt and store electronic documents. In such a document management system, it is common to so arrange it that an administrator can manage the encrypted electronic documents in addition to users who specify that the encrypted electronic documents are to be archived in the document management system (that is, in addition to the owners of these electronic documents). In other words, the administrator has the right to view all electronic documents inclusive of electronic documents that have been encrypted. As a result, even if the owner of an encrypted electronic document archived in an electronic document management system is no longer known, it is possible for this encrypted electronic document to be viewed, edited and deleted, etc., according to the right possessed by the administrator.

On the other hand, if it is so arranged that the administrator is capable of viewing an electronic document, this means that there will be an increase in the number of people who can access the electronic document. This results in a decline is security. In order to deal with this situation, the encryption of files so as to deny access even to an administrator has been considered (see the specification of Japanese Patent Application Laid-Open No. 2003-242005).

However, a problem which arises is that in a case where manipulation such as the viewing of an encrypted electronic document is disabled under administrative privilege, the encrypted electronic document will not be able to be manipulated, e.g., viewed, permanently if the owner of the managed encrypted electronic document is no longer known. Thus, it is difficult to administer encrypted electronic documents appropriately in a document management system.

### SUMMARY OF THE INVENTION

According to the present invention, the foregoing problem is solved by providing a document management apparatus comprising an input unit, which is operative when an encrypted electronic document is stored, for allowing input of a first password that is for decrypting the electronic document, and input of time information on which decryption of the electronic document is permitted utilizing the first password, and a first storage unit adapted for storing the first password and the time information, which have been input by said input unit, in association with the encrypted electronic document.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a flowchart of processing corresponding to a first embodiment of the present invention;

FIG. 2 is a diagram illustrating an example of a dialog-box screen corresponding to the first embodiment;

FIG. 3 is a diagram illustrating another example of a dialog-box screen corresponding to the first embodiment;

FIG. 4 is a diagram illustrating another example of a dialog-box screen that accepts input of a password and date and time setting corresponding to the first embodiment;

FIG. 5 is a flowchart of processing corresponding to a second embodiment of the present invention;

FIG. 6 is a diagram illustrating an example of the configuration of a document management system corresponding to the first embodiment; and

FIG. 7 illustrates an example of the hardware configuration of a document management apparatus corresponding to the first embodiment.

### DETAILED DESCRIPTION OF THE PREFERRED EMBODIMENTS

Preferred embodiments of the present invention will now be described in detail in accordance with the accompanying drawings.

### First Embodiment

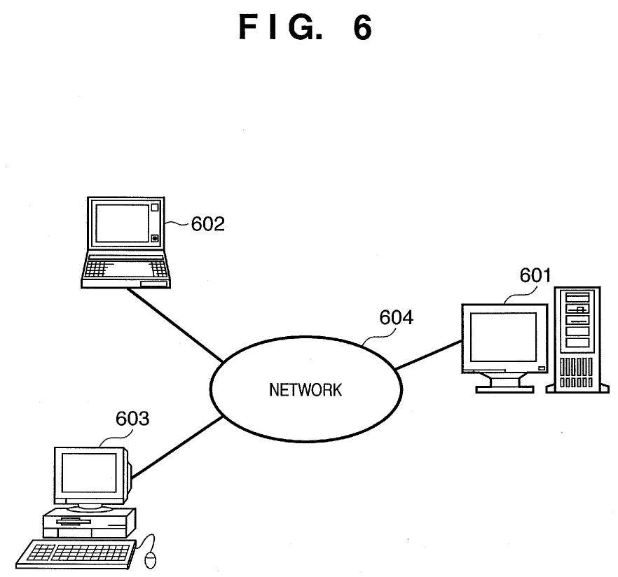

FIG. 6 is a diagram illustrating an example of the configuration of a document management system corresponding to a first embodiment of the invention. As shown in FIG. 6, a document management apparatus 601 corresponding to this embodiment is connected to user terminals 602 and 603 via a network 604 and accepts import of electronic documents. The user terminals 602 and 603 are information processing units each constituted by a general-purpose personal computer or the like. The user terminals 602 and 603 create electronic documents utilizing a prescribed application program such as a word processor and are capable of encrypting the created electronic documents and registering them in the document management apparatus 601. Only two user terminals are shown in FIG. 6. However, the drawing is simplified in order to simplify the description and a larger number of user terminals may be connected to the network 604 and these user terminals may also be capable of accessing the document management apparatus 601.

The network 604 connects the document management apparatus 601 to the user terminals 602 and 603. The network 604 may be a local-area network (LAN) or the Internet.

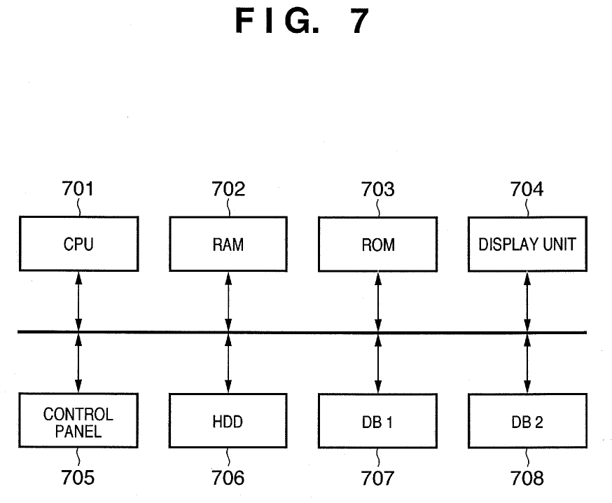

An example of the hardware configuration of the document management apparatus 601 will be described with reference to FIG. 7. As shown in FIG. 7, the document management apparatus 601 includes a CPU 701 that controls the overall operation of the document management apparatus, and a system work memory 702, which is a RAM, for allowing the CPU 701 to operate. A program that conforms to the functions the document management apparatus is to implement is stored in the RAM 702. A ROM 703 stores the system booting program, etc. A display unit 704, which is constituted by a liquid crystal display or LED, etc., displays prescribed information. A control panel 705 is equipped with input keys for accepting inputs from the administrator.

A hard-disk drive 706 stores programs necessary to implement prescribed functions in the document management apparatus. A first database 707 stores an electronic document, which the user of the user terminal 602 or 603 has generated and which has been imported, together with a password and time information regarding a date and time. A second database 708 stores an electronic document, which has been re-encrypted using the password of the administrator, together with the password of the administrator after a date and time set by the user has passed.

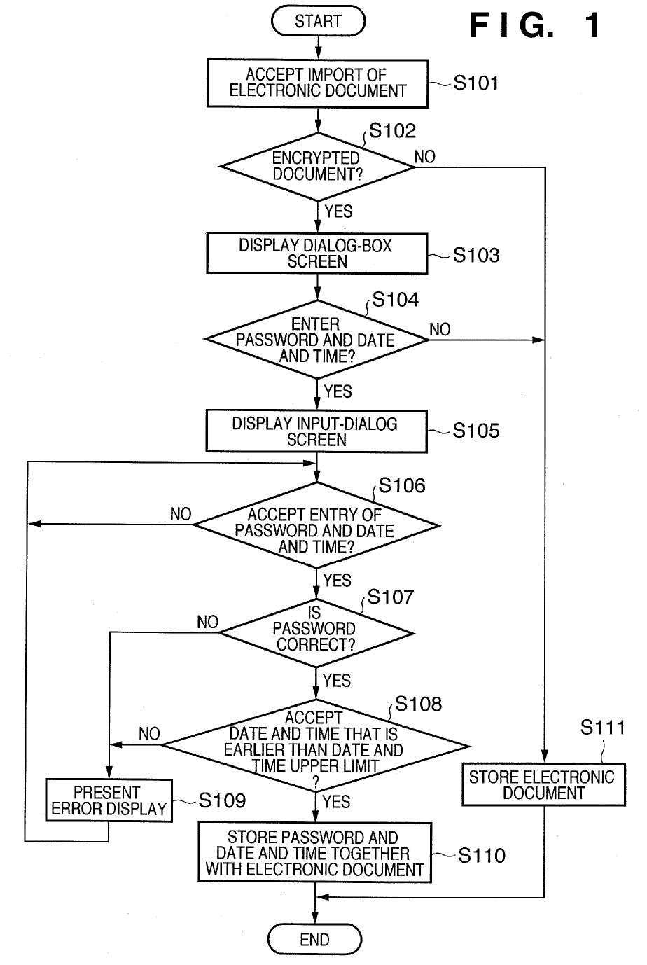

The flow of processing in the document management apparatus 601 corresponding to this embodiment will be described with reference to the flowchart of FIG. 1. FIG. 1 is a flowchart of processing corresponding to an example of processing in which an electronic document is imported to the document management apparatus 601.

At step S101 in FIG. 1, a request to import a certain electronic document to the document management apparatus 601 is accepted from the user. “Import” of an electronic document means processing for registering and storing an electronic document, which has been created by the user, in a database of the document management apparatus.

Next, at step S102, it is determined based upon the content of the electronic document whether or not the imported electronic document has been encrypted. The determination as to whether the electronic document has been encrypted can be performed as follows, by way of example, where it is assumed that a PDF file has been imported to the document management apparatus. The present invention, however, is not limited to a PDF file. The document management apparatus conducts a search to determine whether the character string “/Encrypt” is inside a dictionary in the trailer section of the PDF file. If the corresponding character string is found, this PDF file can be regarded as an encrypted file. If the corresponding character string is not found, then it is decided that the PDF file has not been encrypted.

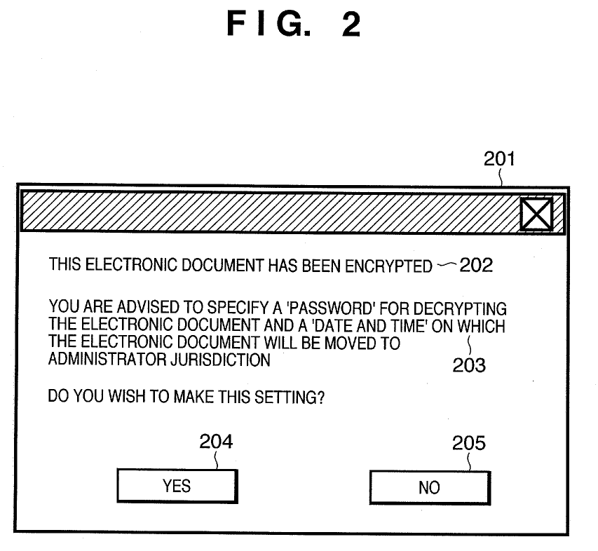

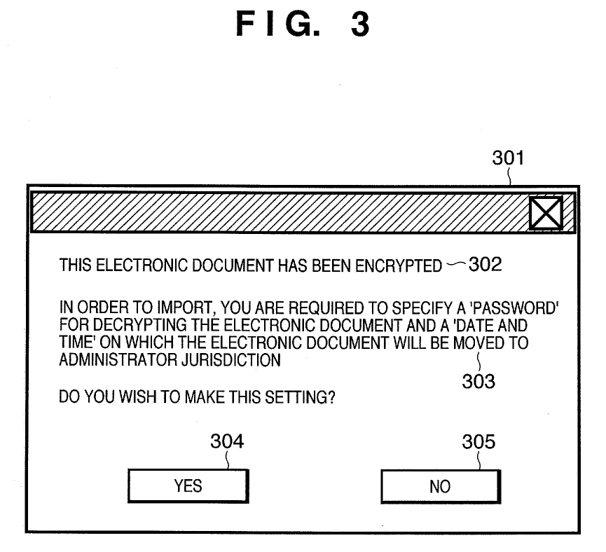

If it is determined at step S102 that the electronic document has not been encrypted (“NO” at step S102), control proceeds to step S111 and processing is executed to store the accepted electronic document in the first database 707 as is. On the other hand, if the electronic document has been encrypted (“YES” at step S102), then control proceeds to step S103, where a prescribed dialog-box screen is displayed for the user to view. Either of two patterns illustrated in FIGS. 2 and 3 appears on the dialog-box screen displayed at step S103.

With the document management apparatus corresponding to this embodiment, the type of dialog-box screen display presented to the user to request an input can be set to that displayed in either FIG. 2 or FIG. 3. In FIG. 2, a message 202 reading “THIS ELECTRONIC DOCUMENT HAS BEEN ENCRYPTED” and a message 203 reading “YOU ARE ADVISED TO SPECIFY A ‘PASSWORD’ FOR DECRYPTING THE ELECTRONIC DOCUMENT AND A ‘DATE AND TIME’ ON WHICH THE ELECTRONIC DOCUMENT WILL BE MOVED TO ADMINISTRATOR JURISDICTION” are being displayed in a dialog-box screen 201. Thus, in FIG. 2, entry of a “PASSWORD” and “DATE AND TIME” is not necessarily an import requirement. If the user him/herself wishes to enter a “PASSWORD” and “DATE AND TIME”, then the user can select a “YES” button 204. If the user does not wish to make these entries, then the user can select a “NO” button 205.

On the other hand, in FIG. 3, a message 302 reading “THIS ELECTRONIC DOCUMENT HAS BEEN ENCRYPTED” and a message 303 reading “IN ORDER TO IMPORT, YOU ARE REQUIRED TO SPECIFY A ‘PASSWORD’ FOR DECRYPTING THE ELECTRONIC DOCUMENT AND A ‘DATE AND TIME’ ON WHICH THE ELECTRONIC DOCUMENT WILL BE CHANGED TO ADMINISTRATOR JURISDICTION” are being displayed in a dialog-box screen 301. Thus, in FIG. 3, entry of a “PASSWORD” and “DATE AND TIME” is a requirement for import. In order to continue with import processing, the user must input a “PASSWORD” and “DATE AND TIME” and select a “YES” button 304. If import processing is not to continue, then the user selects a “NO” button 305 and quits import processing per se.

It should be noted that it is also possible to so arrange it that an encrypted electronic document is imported directly without displaying the dialog-box screen shown in FIG. 2 or 3.

Description of the flow of processing will continue on the assumption that the dialog-box screen 201 of FIG. 2 is displayed in this embodiment. When the dialog-box screen 201 corresponding to FIG. 2 is displayed at step S103, the user selects either button 204 or button 205. Then, at step S104, the button input from the user is accepted and, if selection of button 204 is accepted, then control proceeds to step S105. On the other hand, if selection of button 205 is accepted, then control proceeds to step Sill, where processing for the electronic document is stored in the first database 707 and processing is exited.

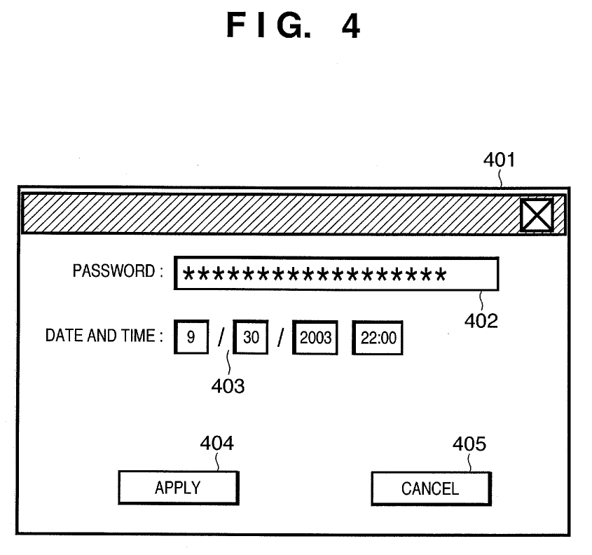

A dialog-box screen 401 of the kind shown in FIG. 4 is displayed at step S105. A text field 402 and text field 403 are displayed on the dialog-box screen 401. The text field 402 is an input field for inputting the password of the encrypted electronic document for which import is being attempted. The text field 403 is an input field for inputting a date and time on which processing is to be executed to decrypt the encrypted electronic document using the set password, re-encrypt the electronic document using an administrator password and move the re-encrypted electronic document to the directory of an administrator jurisdiction specified by the administrator.

The entry of the “PASSWORD” and “DATE AND TIME” from the user is accepted at step S106. Completion of the entry is performed by operating an “APPLY” button 404 on the dialog-box screen 401 of FIG. 4. If the entry is to be cancelled, then a “CANCEL” button 405 is operated.

If operation of the “APPLY” button 404 is accepted (“YES” at step S106), then whether the entered password is correct or not is determined at step S107 based upon whether the encryption that has been applied to the electronic document can be removed by the entered password. If the entered password is correct (“YES” at step S107), then control proceeds to step S108. Here it is determined whether the date and time entered by the user is a date and time earlier than an upper limit of date and time that has been set in advance by the administrator of the document management apparatus. If the date and time entered by the user is earlier than the upper limit (“YES” at step S108), then control proceeds to step S110. Here the accepted password and date and time are stored together with the electronic document in the first database 707 and processing is exited. It should be noted that the password stored at step S110 is stored beforehand so as to enable viewing by an administrator, etc.

On the other hand, if the entered password is not correct (“NO” at step S107), or if the date and time entered by the user is not earlier than the upper limit (“NO” at step S108), then an error display and re-display of the input dialog screen are presented at step S109. Control then proceeds to step S106 again, where the entry of a password and date and time is accepted.

It should be noted that in the description rendered above, the dialog screen of FIG. 2 is displayed at step S103. However, it may be so arranged that the dialog-box screen of FIG. 3 is displayed at step S103. If such a configuration is adopted, then processing is terminated without storing the electronic document when it is determined that the button 305 has been selected at step S104. In a case where button 304 is selected at step S104, on the other hand, then control proceeds to step S105 just as in the case of FIG. 2.

Thus, the document management system corresponding to this embodiment is such that when import of an electronic document is accepted, an electronic-document encryption password and the setting of a date and time for shifting to administrator jurisdiction can be accepted. Accordingly, in a fixed period of time set by the user him/herself, even the administrator cannot view an electronic document without permission and, hence, the confidentiality of the document is maintained. Further, upon elapse of this fixed period of time, it is possible for the administrator to perform decryption using a password. Therefore, even if the owner of an encrypted electronic document is no longer known, a problem wherein the encrypted electronic document can never be manipulated, e.g., viewed, is solved.

### Second Embodiment

This embodiment will be described with regard to a case where a password of an encrypted electronic document is removed and the document is re-encrypted using an administrator password when a date and time specified in advance arrives.

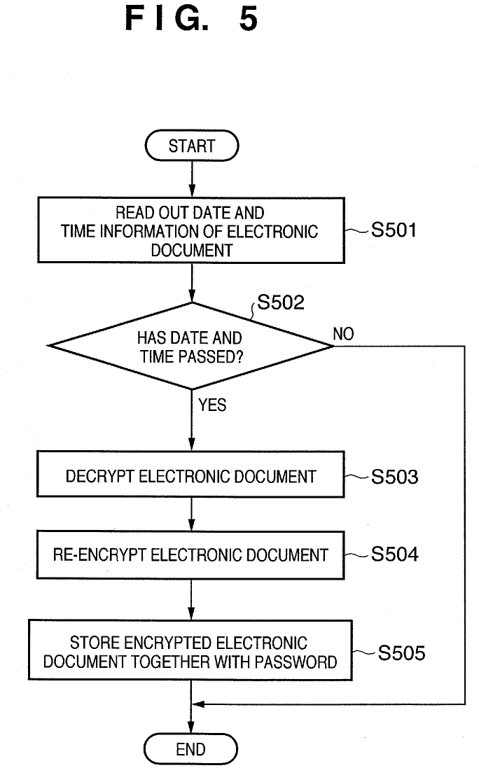

FIG. 5 is a flowchart of processing according to this embodiment. At step S501 in FIG. 5, time information that has been stored together with an electronic document is read out of the first database 767. Next, at step S502, the time information read out and the present date and time are compared and it is determined whether the date and time set with regard to the electronic document has passed. If it is determined that the set date and time has not passed (“NO” at step S502), processing is exited as is.

On the other hand, if it is determined that the set date and time has passed (“YES” at step S502), control proceeds to step S503. Here the electronic document and password that have been stored together with the date and time are read out of the first database 707 and the electronic document is decrypted using the password that has been read out. Next, at step S504, the electronic document is re-encrypted utilizing the password that has been assigned to the administrator. Then, at step S505, the re-encrypted electronic document is stored in the second database 708 together with the administrator password and processing is exited.

Thus, with the document management system corresponding to this embodiment, it is determined whether a date and time regarding an electronic document has passed. If the date and time has passed, then the electronic document is decrypted using the password managed in the first database 707 together with the electronic document, the electronic document is re-encrypted using the administrator password and the document is moved to and stored in the second database 708 exclusively for the administrator.

As a result, if the owner of an encrypted electronic document among such documents being managed in a document management apparatus becomes unknown, this document becomes manipulatable by the administrator upon elapse of a fixed period of time. This makes it possible to prevent some encrypted electronic documents from becoming permanently unmanipulatable, e.g., permanently unviewable.

In accordance with the present invention corresponding to the embodiments set forth above, the administrator of an electronic document management system does not have the right to, e.g., view an encrypted electronic document in this system until a designated date and time arrives. The confidentiality of an encrypted electronic document, therefore, is maintained. Further, by placing the encrypted electronic document under the jurisdiction of the administrator on the designated date and time, it will be possible to manipulate the encrypted electronic document, e.g., to view the document, even in the event that the password of the encrypted electronic document is forgotten or the creator thereof cannot be ascertained.

It should be noted that although a user password is used in the above embodiments as a code for performing decryption and a code for performing encryption, this does not impose a limitation upon the present invention; other codes (e.g., a secret key or biological information such as a fingerprint) may just as well be employed.

### Other Embodiments

Note that the present invention can be applied to an apparatus comprising a single device or to system constituted by a plurality of devices.

Furthermore, the invention can be implemented by supplying a software program, which implements the functions of the foregoing embodiments, directly or indirectly to a system or apparatus, reading the supplied program code with a computer of the system or apparatus, and then executing the program code. In this case, so long as the system or apparatus has the functions of the program, the mode of implementation need not rely upon a program.

Accordingly, since the functions of the present invention are implemented by computer, the program code installed in the computer also implements the present invention. In other words, the claims of the present invention also cover a computer program for the purpose of implementing the functions of the present invention.

In this case, so long as the system or apparatus has the functions of the program, the program may be executed in any form, such as an object code, a program executed by an interpreter, or script data supplied to an operating system.

Examples of storage media that can be used for supplying the program are a floppy disk, a hard disk, an optical disk, a magneto-optical disk, a CD-ROM, a CD-R, a CD-RW, a magnetic tape, a non-volatile type memory card, a ROM, and a DVD (DVD-ROM, DVD-R or DVD-RW).

As for the method of supplying the program, a client computer can be connected to a website on the Internet using a browser of the client computer, and the computer program of the present invention or an automatically-installable compressed file of the program can be downloaded to a recording medium such as a hard disk. Further, the program of the present invention can be supplied by dividing the program code constituting the program into a plurality of files and downloading the files from different websites. In other words, a WWW (World Wide Web) server that downloads, to multiple users, the program files that implement the functions of the present invention by computer is also covered by the claims of the present invention.

It is also possible to encrypt and store the program of the present invention on a storage medium such as a CD-ROM, distribute the storage medium to users, allow users who meet certain requirements to download decryption key information from a website via the Internet, and allow these users to decrypt the encrypted program by using the key information, whereby the program is installed in the user computer.

Besides the cases where the aforementioned functions according to the embodiments are implemented by executing the read program by computer, an operating system or the like running on the computer may perform all or a part of the actual processing so that the functions of the foregoing embodiments can be implemented by this processing.

Furthermore, after the program read from the storage medium is written to a function expansion board inserted into the computer or to a memory provided in a function expansion unit connected to the computer, a CPU or the like mounted on the function expansion board or function expansion unit performs all or a part of the actual processing so that the functions of the foregoing embodiments can be implemented by this processing.

As many apparently widely different embodiments of the present invention can be made without departing from the spirit and scope thereof, it is to be understood that the invention is not limited to the specific embodiments thereof except as defined in the appended claims.

This application claims the benefit of Japanese Application No. 2005-144229 filed on May 17, 2005, which is hereby incorporated by reference herein in its entirety.

What is claimed is:

1. A document management apparatus comprising:
an input unit, which is operative when an encrypted electronic document is stored, for allowing input of a first password that is for decrypting the electronic document, and input of time information on which decryption of the electronic document is permitted utilizing the first password; and
a first storage unit adapted for storing the first password and the time information, which have been input by said input unit, in association with the encrypted electronic document.

2. The apparatus according to claim 1, further comprising a first determination unit adapted for determining whether an entered electronic document has been encrypted or not;
wherein if said first determination unit determines that the electronic document has been encrypted, then said input allows input of the first password and the time information.

3. The apparatus according to claim 2, wherein if said first determination unit determines that the electronic document has not been encrypted, then said storage unit stores the electronic document as is.

4. The apparatus according to claim 1, wherein said input unit includes designating unit adapted for allowing the user to designate whether or not the first password and the time information are to be input;
if input is designated by the user using said designation unit, then said input unit allows the user to input the first password and the time information and said storage unit stores the first password and the time information in association with the encrypted electronic document; and
if input is not designated by the user using said designation unit, then said storage unit stores the encrypted electronic document without associating it with the first password and the time information.

5. The apparatus according to claim 1, wherein said input unit includes designating unit adapted for allowing the user to designate whether or not the first password and the time information are to be input;
if input is designated by the user using said designation unit, then said input unit allows the user to input the first password and the time information and said storage unit stores the first password and the time information in association with the encrypted electronic document; and
if input is not designated by the user using said designation unit, then control is exercised in such a manner that said storage unit will not store the encrypted electronic document.

6. The apparatus according to claim 1, further comprising:
a second determination unit adapted for determining whether the date and time indicated by the time information has passed based upon the stored time information and the present date and time; and
a decryption unit, which is operative if said second determination unit determines that the date and time has passed, for decrypting the electronic document, which has been stored in said first storage unit, utilizing the first password.

7. The apparatus according to claim 6, further comprising:
an encryption unit adapted for re-encrypting the electronic document, which has been decrypted by said decryption unit, utilizing a second password that is different from the first password; and
a second storage unit adapted for storing the electronic document that has been re-encrypted utilizing the second password.

8. A method of controlling a document management apparatus, comprising:
an input step, which is operative when an encrypted electronic document is stored, of allowing input of a first password that is for decrypting the electronic document, and input of time information on which decryption of the electronic document is permitted utilizing the first password; and
a first storage step of storing the first password and the time information, which have been input at said input step, in association with the encrypted electronic document.

9. The method according to claim 8, further comprising a first determination step of determining whether an entered electronic document has been encrypted or not;
wherein if it is determined at said first determination step that the electronic document has been encrypted, then input of the first password and the time information is allowed at said input step.

10. The method according to claim 9, wherein if it is determined at said first determination step that the electronic document has not been encrypted, then the electronic document is stored as is at said first storage step.

11. The method according to claim 8, wherein said input step includes a designating step of allowing the user to designate whether or not the first password and the time information are to be input;
if input is designated by the user at said designation step, then, at said input step, the user is allowed to input the first password and the time information and said storage unit stores the first password and the time information in association with the encrypted electronic document; and
if input is not designated by the user at said designation step, then, at said storage step, the encrypted electronic document is stored without it being associated with the first password and the time information.

12. The method according to claim 8, wherein said input step includes a designating step of allowing the user to designate whether or not the first password and the time information are to be input;
if input is designated by the user at said designation step, then, at said input step, the user is allowed to input the first password and the time information and said storage unit stores the first password and the time information in association with the encrypted electronic document; and
if input is not designated by the user at said designation step, then control is exercised in such a manner that the encrypted electronic document will not be stored at said storage step.

13. The method according to claim 8, further comprising:
a second determination step of determining whether the date and time indicated by the time information has passed based upon the stored time information and the present date and time; and
a decryption step, which is operative if it is determined at said second determination step that the date and time has passed, of decrypting the electronic document, which has been stored in the first storage unit, utilizing the first password.

14. The method according to claim 13, further comprising:
an encryption step of re-encrypting the decrypted electronic document, which has been decrypted at said decryption step, utilizing a second password that is different from the first password; and
a second storage step of storing the electronic document encrypted utilizing the second password in a second storage unit.

15. A computer program for causing a computer to execute a method of controlling a document management apparatus, said method comprising:
an input step, which is operative when an encrypted electronic document is stored, of allowing input of a first password that is for decrypting the electronic document, and input of time information on which decryption of the electronic document is permitted utilizing the first password; and
a first storage step of storing the first password and the time information, which have been input at said input step, in association with the encrypted electronic document.

16. A computer-readable storage medium storing a computer program for causing a computer to execute a method of controlling a document management apparatus, said method comprising:
an input step, which is operative when an encrypted electronic document is stored, of allowing input of a first password that is for decrypting the electronic document, and input of time information on which decryption of the electronic document is permitted utilizing the first password; and
a first storage step of storing the first password and the time information, which have been input at said input step, in association with the encrypted electronic document.

17. A document management apparatus comprising:
an input unit, which is operative when an encrypted electronic document is stored, for allowing a user to input a decryption code that is for decrypting the electronic document, and time information on which decryption of the electronic document is permitted utilizing the decryption code; and
a storage unit for storing the decryption code and the time information, which have been input at said input unit, in association with the encrypted electronic document.

18. A method of controlling a document management apparatus, comprising:
an input step, which is operative when an encrypted electronic document is stored, of allowing a user to input a decryption code that is for decrypting the electronic document, and time information on which decryption of the electronic document is permitted utilizing the decryption code; and
a storage step of storing the decryption code and the time information, which have been input at said input step, in association with the encrypted electronic document.
